(19) United States
(12) Patent Application Publication
(10) Pub. No.: US 2023/0082902 A1
(43) Pub. Date: Mar. 16, 2023

(54) SINTER POWDER (SP) CONTAINING A SEMI-CRYSTALLINE TEREPHTHALATE POLYESTER

(71) Applicant: BASF SE, Ludwigshafen am Rhein (DE)

(72) Inventors: Claus GABRIEL, Ludwigshafen am Rhein (DE); Jordan Thomas KOPPING, Ludwigshafen am Rhein (DE); Thomas MEIER, Ludwigshafen am Rhein (DE); Erik GUBBELS, Ludwigshafen am Rhein (DE); Ruth LOHWASSER, Ludwigshafen am Rhein (DE); Simon KNIESEL, Ludwigshafen am Rhein (DE)

(21) Appl. No.: 17/783,278

(22) PCT Filed: Nov. 17, 2020
(86) PCT No.: PCT/EP2020/082408

§ 371 Date: Jun. 8, 2022

(30) Foreign Application Priority Data
Dec. 11, 2019 (EP) 19215327.8

(51) Int. Cl. B29C 64/153; C08L 67/02; B33Y 70/00; C08G 63/183; C08J 3/12

(52) U.S. Cl. CPC B29C 64/153; C08L 67/02; B33Y 70/00; C08G 63/183; C08J 3/12; C08J 2367/03; B29K 2067/003

(57) ABSTRACT

The present invention relates to a sinter powder (SP) comprising at least one semicrystalline terephthalate polyester (A) which is prepared by reacting at least one aromatic dicarboxylic acid (a) and at least two aliphatic diols (b1) and (b2), where the aliphatic diol (b1) is neopentyl glycol. The present invention further relates to a method of producing the sinter powder (SP), and to a method of producing a shaped body by sintering the sinter powder (SP). The present invention further relates to the shaped body obtainable by the sintering. The present invention also relates to the use of the sinter powder (SP) in a sintering method.

The present invention relates to a sinter powder (SP) comprising at least one semicrystalline terephthalate polyester (A) which is prepared by reacting at least one aromatic dicarboxylic acid (a) and at least two aliphatic diols (b1) and (b2), where the aliphatic diol (b1) is neopentyl glycol. The molar ratio of component (a) to component (b1) in the preparation of the at least one semicrystalline terephthalate polyester (A) is in the range from 1:0.15 to 1:0.65 [mol/mol]. The present invention further relates to a method of producing the sinter powder (SP), and to a method of producing a shaped body by sintering the sinter powder (SP). The present invention further relates to the shaped body obtainable by the sintering. The present invention also relates to the use of the sinter powder (SP) in a sintering method.

The rapid provision of prototypes is a problem often addressed in recent times. One method which is particularly suitable for this “rapid prototyping” is selective laser sintering (SLS). This involves selectively exposing a plastic powder in a chamber to a laser beam. The powder melts; the molten particles coalesce and resolidify. Repeated application of plastic powder and subsequent exposure to a laser allows modeling of three-dimensional shaped bodies.

The method of selective laser sintering for producing shaped bodies from pulverulent polymers is described in detail in patent specifications U.S. Pat. No. 6,136,948 and WO 96/06881.

Novel variants of selective laser sintering are high-speed sintering (HSS) or what is called multijet fusion technology (MJF) from HP. In this method, by spray application of an infrared-absorbing ink onto the component cross section to be sintered, followed by melting with an infrared source, a higher processing speed is achieved compared to selective laser sintering.

A factor of particular significance in high-speed sintering or multijet fusion technology and also in selective laser sintering is the sintering window of the sinter powder. This should be as broad as possible in order to reduce warpage of components in the laser sintering operation. For this reason, particularly the processing of semicrystalline terephthalate polyester-based sinter powders is frequently difficult since semicrystalline terephthalate polyesters have a narrow sintering window and crystallize very quickly, and so components having high warpage are frequently obtained.

A further important point in high-speed sintering or multijet fusion technology and also in selective laser sintering is the level of the melting temperature of the sinter powder. This should not be more than 200° C., in order firstly to minimize the energy required in the sintering operation, and secondly to assure sinterability of the sinter powder in standard laser sintering systems, which have a maximum build space temperature of about 200° C. Since pure polybutylene terephthalate (PBT), for example, has a melting temperature of about 220° C., the processing of pure polybutylene terephthalate powders in standard laser sintering systems is generally very difficult. The same also applies, for example, to pure polyethylene terephthalate (PET) powder, since pure polyethylene terephthalate likewise has a high melting temperature of more than 250° C.

To increase the sintering window and/or to lower the melting temperature, the sinter powders based on semicrystalline terephthalate polyesters are therefore typically mixed with further, preferably amorphous, polymer powders, or sinter powders based on terephthalate copolymers are used. However, the shaped bodies produced from these sinter powders to date frequently have inadequate mechanical properties, for example too low a tensile modulus of elasticity or too low a tensile strength.

The article “Production and Processing of a spherical polybutylene terephthalate powder for laser sintering” by Rob G. Kleijnen, Manfred Schmid and Konrad Wegener (Applied Sciences, 2019, 9, 1308) describes the production of a spherical PBT powder and the use thereof in a selective laser sintering process. The shaped bodies produced from the PBT powder have significant warpage and inadequate mechanical properties, such as a low tensile modulus of elasticity, low elongation at break and low tensile strength.

The article “Comparison of crystallization characteristics and mechanical properties of poly(butylene terephthalate) processed by laser sintering and injection molding” by S. Arai et al. (Materials and Design, 2017, 113, 214) describes the production of a powder from a PBT copolymer comprising 10 mol % of isophthalic acid. The powder has a melting temperature of about 208° C. and may be sintered in a selective sintering process at a powder bed temperature of 190° C. to give shaped bodies.

US 2015/0259530 discloses a composition comprising a semicrystalline PET copolyester, a glycol-modified amorphous PET and an impact modifier for use in a sintering method.

U.S. Pat. No. 8,247,492 describes sinterable powder compositions comprising a semicrystalline aromatic polyester and an amorphous aromatic polyester. The semicrystalline aromatic polyester is prepared by reaction of terephthalic acid, isophthalic acid, butane-1,4-diol and propane-1,3-diol; the amorphous aromatic polyester is prepared by reaction of terephthalic acid, isophthalic acid and ethylene glycol. The powder compositions have melting temperatures in the range from 145 to 150° C. and may be sintered to give shaped bodies having a modulus of elasticity of 1000 MPa and a tensile strength of 20 MPa.

WO 2019/177850 describes a build material for additive manufacturing applications, comprising a build composition in powder form, wherein the build composition comprises a semicrystalline polymer. The semi-crystalline polymer may be a polyester or copolyester and may comprise terephthalic acid radicals, and neopentyl glycol as glycol radical.

A disadvantage of the semicrystalline terephthalate polyester-based sinter powders described in the prior art for production of shaped bodies by selective laser sintering is that the sintering window of the sinter powders is frequently insufficiently broad, such that the shaped bodies frequently warp during production by selective laser sintering. This warpage virtually rules out use or further processing of the shaped bodies. Even during the production of the shaped bodies, the warpage can be so severe that further layer application is impossible and therefore the production process has to be stopped. If shaped bodies are produced from sinter powders that comprise a further polymer as well as the semicrystalline terephthalate polyester, or that comprise the terephthalate polyester in the form of a copolymer, these shaped bodies frequently have unsatisfactory mechanical properties, such as a low tensile modulus of elasticity and/or low tensile strength.

It is thus an object of the present invention to provide a sinter powder which, in a method of producing shaped bodies by laser sintering, has the aforementioned disadvantages of the sinter powders and methods described in the prior art only to a lesser degree, if at all. The sinter powder and the method should be producible and performable in a very simple and inexpensive manner.

This object is achieved by a sinter powder (SP) comprising the following components (A) and optionally (B), (C) and/or (D):
(A) at least one semicrystalline terephthalate polyester which is prepared by reacting at least components (a) and (b):
   (a) at least one aromatic dicarboxylic acid and
   (b) at least two aliphatic diols (b1) and (b2), where the aliphatic diol (b1) is neopentyl glycol,
(B) optionally at least one further polymer,
(C) optionally at least one additive and/or
(D) optionally at least one reinforcer, where

the molar ratio of component (a) to component (b1) in the preparation of the at least one semicrystalline terephthalate polyester (A) is in the range from 1:0.15 to 1:0.65 [mol/mol].

It has been found that, surprisingly, the sinter powder (SP) of the invention has distinctly slowed crystallization kinetics and hence such a broadened sintering window (W_{SP}) or such a broadened processing temperature range that the shaped body produced by sintering the sinter powder (SP) has distinctly reduced warpage, if any. Furthermore, the melting temperature of the sinter powder (SP) of the invention is much lower compared to the melting temperature of sinter powders from the prior art comprising a semicrystalline terephthalate polyester, and so the sinter powder (SP) of the invention can be used without difficulty in all standard laser sintering systems having maximum build space temperatures of 200° C. Moreover, the energy demand on sintering is distinctly smaller by virtue of the lowered melting temperature.

Furthermore, it has been found that, surprisingly, the shaped bodies produced from the sinter powder of the invention have very good mechanical properties, such as high tensile modulus of elasticity and high tensile strength.

In addition, degradation of the sinter powder (SP) used in the process of the invention is low even after thermal treatment. This means that sinter powder (SP) not melted in the production of the shaped body can be reused. Even after several laser sintering cycles, the sinter powder (SP) has similarly advantageous sintering properties to those in the first sintering cycle.

Sinter Powder (SP)

According to the invention, the sinter powder (SP) comprises at least one semicrystalline terephthalate polyester as component (A), optionally at least one further polymer as component (B), optionally at least one additive as component (C), and optionally at least one reinforcer as component (D).

In the context of the present invention the terms “component (A)” and “at least one semicrystalline terephthalate polyester” are used synonymously and therefore have the same meaning.

The same applies to the terms “component (B)” and “at least one further polymer”. These terms are likewise used synonymously in the context of the present invention and therefore have the same meaning.

Accordingly, the terms “component (C)” and “at least one additive”, and the terms “component (D)” and “at least one reinforcer”, are also each used synonymously in the context of the present invention and have the same meaning.

The sinter powder (SP) may comprise component (A) and optionally components (B), (C) and (D) in any desired amounts.

For example, the sinter powder (SP) comprises in the range from 15% to 100% by weight of component (A), in the range from 0% to 25% by weight of component (B), in the range from 0% to 20% by weight of component (C) and in the range from 0% to 40% by weight of component (D), based in each case on the sum total of the percentages by weight of components (A) and optionally (B), (C) and (D), preferably based on the total weight of the sinter powder (SP).

In a preferred embodiment, the sinter powder (SP) comprises in the range from 15% to 95% by weight of component (A), in the range from 0% to 25% by weight of component (B), in the range from 0% to 20% by weight of component (C) and in the range from 5% to 40% by weight of component (D), based in each case on the sum total of the percentages by weight of components (A) and (D) and optionally (B) and (C), preferably based on the total weight of the sinter powder (SP).

In an alternative preferred embodiment, the sinter powder (SP) comprises

in the range from 15% to 98.9% by weight, preferably in the range from 17% to 92% by weight, of component (A),

in the range from 1% to 25% by weight, preferably in the range from 2% to 23% by weight, of component (B),

in the range from 0.1% to 20% by weight, preferably in the range from 1% to 20% by weight, of component (C) and

in the range from 0% to 40% by weight, preferably in the range from 5% to 40% by weight, of component (D),

based in each case on the sum total of the percentages by weight of components (A), (B), (C) and optionally (D), preferably based on the total weight of the sinter powder (SP).

The percentages by weight of components (A) and optionally (B), (C) and (D) typically add up to 100% by weight.

The sinter powder (SP) comprises particles. These particles have, for example, a size (D50) in the range from 10 to 250 μm, preferably in the range from 15 to 200 μm, more preferably in the range from 25 to 90 μm and especially preferably in the range from 40 to 80 μm.

The present invention therefore also provides a sinter powder (SP), wherein the sinter powder has a median particle size (D50) in the range from 10 to 250 μm.

The sinter powder (SP) of the invention has, for example,

a D10 in the range from 10 to 60 μm,

a D50 in the range from 25 to 90 μm and

a D90 in the range from 50 to 150 μm.

Preferably, the sinter powder (SP) of the invention has

a D10 in the range from 20 to 50 μm,

a D50 in the range from 40 to 80 μm and

a D90 in the range from 80 to 125 μm.

The present invention therefore also provides a sinter powder (SP), wherein the sinter powder (SP) has

a D10 in the range from 10 to 60 μm,

a D50 in the range from 25 to 90 μm and

a D90 in the range from 50 to 150 μm.

In the context of the present invention, the “D10” is to be understood as meaning the particle size at which 10% by volume of the particles based on the total volume of the particles are smaller than or equal to the D10 and 90% by volume of the particles based on the total volume of the particles are larger than the D10. By analogy, the “D50” is understood to mean the particle size at which 50% by volume of the particles based on the total volume of the particles are smaller than or equal to the D50 and 50% by volume of the particles based on the total volume of the particles are larger than the D50. Correspondingly, the “D90” is understood to mean the particle size at which 90% by volume of the particles based on the total volume of the particles are smaller than or equal to the D90 and 10% by volume of the particles based on the total volume of the particles are larger than the D90.

To determine the particle sizes, the sinter powder (SP) is suspended in a dry state using compressed air or in a solvent, for example water or ethanol, and this suspension is analyzed. The D10, D50 and D90 are determined by means of laser diffraction using a Malvern MasterSizer 3000. Evaluation is by means of Fraunhofer diffraction.

The sinter powder (SP) has preferably been heat treated.

Preferably, the sinter powder is heat-treated at a temperature T_{T} in the range from 80 to 140° C., more preferably in the range from 85 to 135° C., and most preferably in the range from 100 to 130° C.

In a preferred embodiment, the sinter powder (SP) is heat treated within a period in the range from 1 to 20 hours. The heat treatment is preferably effected in a drying cabinet under reduced pressure or under protective gas. The protective gas used is, for example, nitrogen.

The sinter powder (SP) typically has a melting temperature (T_{M}) in the range from 130 to 210° C. Preferably, the melting temperature (T_{M}) of the sinter powder (SP) is in the range from 135 to 205° C. and especially preferably in the range from 140 to 180° C.

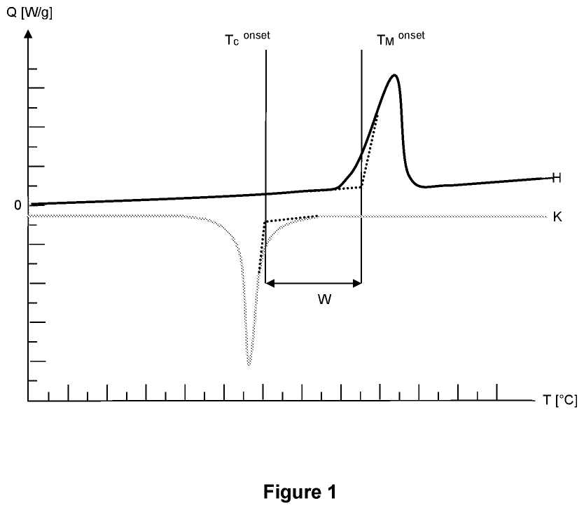

The melting temperature (T_{M}) is determined in the context of the present invention by means of differential scanning calorimetry (DSC). It is customary to measure a heating run (H) and a cooling run (K), each with a constant heating rate or cooling rate in the range from 5 to 25 K/min, preferably at a constant heating rate or cooling rate in the range from 5 to 15 K/min. This gives a DSC diagram as shown by way of example in FIG. 1. The melting temperature (T_{M}) is then understood to mean the temperature at which the melting peak of the heating run (H) of the DSC diagram has a maximum.

The sinter powder (SP) typically also has a crystallization temperature (T_{C}) in the range from 70 to 130° C. Preferably, the crystallization temperature (T_{C}) of the sinter powder (SP) is in the range from 75 to 125° C. and especially preferably in the range from 80 to 120° C.

The crystallization temperature (T_{C}) is determined in the context of the present invention by means of differential scanning calorimetry (DSC). It is customary here to measure a heating run (H) and a cooling run (K), each with a constant heating rate or cooling rate in the range from 5 to 25 K/min, preferably at a constant heating rate or cooling rate in the range from 5 to 15 K/min. This gives a DSC diagram as shown by way of example in FIG. 1. The crystallization temperature (T_{C}) is then the temperature at the minimum of the crystallization peak of the DSC curve.

The sinter powder (SP) typically also has a sintering window (W_{SP}).

If heating run (H) and cooling run (K) are measured with a constant heating rate and cooling rate in the range from 5 to 15 K/min, the sintering window (W_{SP}), as described below, is the difference between the onset temperature of melting (T_{M}^{onset}) and the onset temperature of crystallization (T_{C}^{onset}). The onset temperature of melting (T_{M}^{onset}) and the onset temperature of crystallization (T_{C}^{onset}) are determined as described hereinafter with regard to step c).

The sintering window (W_{SP}) of the sinter powder (SP) is then, for example, in the range from 10 to 40 K (kelvin), more preferably in the range from 15 to 35 K, particularly preferably in the range from 20 to 33 K and especially preferably in the range from 22 to 33 K.

If heating run (H) and cooling run (K) are measured with a constant heating rate and cooling rate in the range from 15 to 25 K/min, the sintering window (W_{SP}) in the context of the present invention is the difference between the onset temperature of melting (T_{M}^{onset}) and the glass transition temperature (T_{G}). The onset temperature of melting (T_{M}^{onset}) and the glass transition temperature (T_{G}) are determined as described hereinafter with regard to step c).

The sintering window (W_{SP}) of the sinter powder (SP) in that case is much broader; it is then, for example, in the range from 20 to 80 K, more preferably in the range from 30 to 70 K.

In addition, the sinter powder (SP) typically has a first enthalpy of fusion ΔH1_{(SP)} and a second enthalpy of fusion ΔH2_{(SP)}, where the enthalpies of fusion ΔH1_{(SP)} and ΔH2_{(SP)} of the sinter powder (SP) are proportional to the area under the melting peak of the first heating run (H1) and of the second heating run (H2) in the DSC diagram respectively. The following general rule is applicable here: The greater the difference between the first enthalpy of fusion ΔH1_{(Sp)} and the second enthalpy of fusion ΔH2_{(SP)}, the slower the crystallization and the broader the sintering window (W_{SP}). In the context of the present invention, the difference between the first enthalpy of fusion ΔH1_{(SP)} and the second enthalpy of fusion ΔH2_{(SP)} is preferably at least 10 J/g, more preferably at least 12 J/g.

The sinter powder (SP) can be produced by any methods known to those skilled in the art. For example, the sinter powder is produced by grinding, by precipitation, by melt emulsification, by spray extrusion or by micropelletization. The production of the sinter powder (SP) by grinding, by precipitation, by melt emulsification, by spray extrusion or by micropelletization is also referred to in the context of the present invention as micronization.

If the sinter powder (SP) is produced by precipitation, components (A) and optionally (B), (C) and (D) are typically mixed with a solvent, and component (A) and optionally component (B) are optionally dissolved in the solvent while heating to obtain a solution. The sinter powder (SP) is subsequently precipitated, for example by cooling the solution, distilling the solvent out of the solution or adding a precipitant to the solution.

The grinding can be conducted by any methods known to those skilled in the art; for example, components (A) and optionally (B), (C) and (D) are introduced into a mill and ground therein.

Suitable mills include all mills known to those skilled in the art, for example classifier mills, opposed jet mills, hammer mills, ball mills, vibratory mills or rotor mills such as pinned disk mills and whirlwind mills.

The grinding in the mill can likewise be effected by any methods known to those skilled in the art. For example, the grinding can take place under inert gas and/or while cooling with liquid nitrogen. Cooling with liquid nitrogen is preferred. The temperature in the grinding is as desired; the grinding is preferably performed at liquid nitrogen temperatures, for example at a temperature in the range from −210 to −195° C. The temperature of the components on grinding in that case is, for example, in the range from −40 to −30° C.

Preferably, the components are first mixed with one another and then ground.

Preferably, at least component (A) is in the form of a pelletized material prior to the micronization. As well as component (A), it is optionally also possible for components (B), (C) and (D) to be in the form of a pelletized material. The pelletized material may, for example, be spherical, cylindrical or ellipsoidal. In the context of the present invention, in a preferred embodiment, a pelletized material comprising components (A) and optionally (B), (C) and (D) in premixed form is used.

The method of producing the sinter powder (SP) in that case preferably comprises the steps of
a) mixing components (A) and optionally (B), (C) and/or (D):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer,
   (C) optionally at least one additive and/or
   (D) optionally at least one reinforcer,
   in an extruder to obtain an extrudate (E) comprising components (A) and optionally (B), (C) and/or (D),
b) pelletizing the extrudate (E) obtained in step A) to obtain a pelletized material (G) comprising components (A) and optionally (B), (C) and/or (D),
c) micronizing the pelletized material (G) obtained in step c) to obtain the sinter powder (SP), preferably by grinding.

The present invention therefore also provides a method of producing a sinter powder (SP), comprising the steps of
a) mixing components (A) and optionally (B), (C) and/or (D):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer,
   (C) optionally at least one additive and/or
   (D) optionally at least one reinforcer,
   in an extruder to obtain an extrudate (E) comprising components (A) and optionally (B), (C) and/or (D),
b) pelletizing the extrudate (E) obtained in step A) to obtain a pelletized material (G) comprising components (A) and optionally (B), (C) and/or (D),
c) micronizing the pelletized material (G) obtained in step c) to obtain the sinter powder (SP).

It will be apparent that, in the case that component (A) is already in pelletized form and the sinter powder (SP) of the invention comprises solely component (A) and not components (B), (C) and (D), steps a) and b) may be dispensed with in the context of the present invention.

In a preferred embodiment, the sinter powder (SP) obtained in step c) is then heat-treated in a step d) at a temperature T_{T} to obtain a heat-treated sinter powder (SP).

The method of producing a heat-treated sinter powder (SP) in that case consequently preferably comprises the following steps:
a) mixing components (A) and optionally (B), (C) and/or (D):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer,
   (C) optionally at least one additive and/or
   (D) optionally at least one reinforcer,
   in an extruder to obtain an extrudate (E) comprising components (A) and optionally (B), (C) and/or (D),
b) pelletizing the extrudate (E) obtained in step a) to obtain a pelletized material (G) comprising components (A) and optionally (B), (C) and/or (D),
c) micronizing the pelletized material (G) obtained in step c) to obtain the sinter powder (SP),
d) heat-treating the sinter powder (SP) obtained in step c) at a temperature T_{T} to obtain a heat-treated sinter powder (SP).

In a further preferred embodiment, the process for producing the sinter powder (SP) comprises the following steps:
a) mixing components (A) and optionally (B), (C) and/or (D):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer,
   (C) optionally at least one additive and/or
   (D) optionally at least one reinforcer,
   in an extruder to obtain an extrudate (E) comprising components (A) and optionally (B), (C) and/or (D),
b) pelletizing the extrudate (E) obtained in step a) to obtain a pelletized material (G) comprising components (A) and optionally (B), (C) and/or (D),
ci) micronizing the pelletized material (G) obtained in step c) to obtain a terephthalate polyester powder (TP),
cii) mixing the terephthalate polyester powder (TP) obtained in step ci) with a flow aid to obtain the sinter powder (SP).

Preferably, the terephthalate polyester powder (TP) obtained in step ci) or the sinter powder (SP) obtained in step cii) is then heat-treated in a step d1) at a temperature T_{T} to obtain a heat-treated sinter powder (SP).

If the sinter powder (SP) comprises component (D), what is preferably obtained is a pelletized material comprising solely components (A) and optionally components (B) and/or (C) in premixed form. The at least one reinforcer (C) is then preferably mixed in only after the micronization step.

The method of producing the sinter powder (SP) in that case preferably comprises the following steps:
a) mixing components (A) and optionally (B) and/or (C):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer, and/or
   (C) optionally at least one additive
   in an extruder to obtain an extrudate (E) comprising components (A) and optionally (B) and/or (C),
b) pelletizing the extrudate (E) obtained in step A) to obtain a pelletized material (G1) comprising components (A) and optionally (B) and/or (C),
c) micronizing the pelletized material (G1) obtained in step c) to obtain a sinter powder (SP1), preferably by grinding,
e) mixing the sinter powder (SP1) and component (D):
   (D) at least one reinforcer,
   to obtain the sinter powder (SP).

Preferably, the sinter powder (SP1) obtained in step c) or the sinter powder (SP) obtained in step e) is then heat-treated in a step d2) at a temperature T_{T} to obtain a heat-treated sinter powder (SP), preference being given to heat-treating the sinter powder (SP1) obtained in step c).

If, during the method of producing the sinter powder (SP), a flow aid is mixed in, the method then preferably comprises the following steps:
a) mixing components (A) and optionally (B) and/or (C):
(A) at least one semicrystalline terephthalate polyester which is prepared by reacting at least components (a) and (b):
   (a) at least one aromatic dicarboxylic acid and
   (b) at least two aliphatic diols (b1) and (b2), where the aliphatic diol (b1) is neopentyl glycol,
(B) optionally at least one further polymer, and/or
(C) optionally at least one additive
in an extruder to obtain an extrudate (E) comprising components (A) and optionally (B) and/or (C),
b) pelletizing the extrudate (E) obtained in step a) to obtain a pelletized material (G1) comprising components (A) and optionally (B) and/or (C),
ci) micronizing the pelletized material (G1) obtained in step c) to obtain a terephthalate polyester powder (TP1), preferably by grinding,
cii) mixing the terephthalate polyester powder (TP1) obtained in step ci) with a flow aid to obtain a sinter powder (SP2),
e) mixing the sinter powder (SP2) and component (D):
   (D) at least one reinforcer,
   to obtain the sinter powder (SP).

Preferably, the terephthalate polyester powder (TP1) obtained in step ci), the sinter powder (SP2) obtained in step cii) or the sinter powder (SP) obtained in step e) is then heat-treated in a step d3) at a temperature T_{T} to obtain a heat-treated sinter powder (SP).

Suitable flow aids are, for example, silicas, amorphous silicon oxide or aluminas. An example of a suitable alumina is Aeroxide® Alu C from Evonik.

The present invention thus also provides a method of producing a sinter powder (SP), in which the flow aid in step cii) is selected from silicas, amorphous silicon oxide and/or aluminas.

If the sinter powder (SP) comprises a flow aid, it is preferably added in method step cii). In one embodiment, the sinter powder (SP) comprises 0.02% to 1% by weight, preferably 0.05% to 0.8% by weight and more preferably 0.1% to 0.6% by weight of flow aid, based in each case on the total weight of the terephthalate polyester powder (TP) or (TP1) and the flow aid.

In respect of the grinding in step c) and in step ci), the details and preferences described above are correspondingly applicable with regard to the grinding.

Steps d), d1), d2) and d3) are preferably conducted at a temperature T_{T} in the range from 80 to 140° C., more preferably in the range from 85 to 135° C., and most preferably in the range from 100 to 130° C.

Steps d), d1), d2) and d3) are additionally preferably conducted within a period in the range from 1 to 20 hours. The heat treatment is preferably effected in a drying cabinet under reduced pressure or under protective gas. The protective gas used is, for example, nitrogen. The heat treatment can be conducted in a static or moving vessel, such as a tumble mixer.

The present invention therefore also further provides the sinter powder (SP) obtainable by the method of the invention.

Component (A)

According to the invention, component (A) is at least one semicrystalline terephthalate polyester.

In the context of the present invention, “at least one semicrystalline terephthalate polyester (A)” means either exactly one semicrystalline terephthalate polyester (A) or a mixture of two or more semicrystalline terephthalate polyesters (A).

What is meant by “semicrystalline” in the context of the present invention is that the semicrystalline terephthalate polyester (A) has an enthalpy of fusion ΔH2_{(A)} of greater than 1 J/g, preferably of greater than 2 J/g, measured in each case by means of differential scanning calorimetry (DSC) to ISO 11357-4:2014.

The at least one semicrystalline terephthalate polyester (A) of the invention thus typically has an enthalpy of fusion ΔH2_{(A)} of greater than 1 J/g, preferably of greater than 2 J/g, measured in each case by means of differential scanning calorimetry (DSC) according to ISO 11357-4:2014.

The at least one semicrystalline terephthalate polyester (A) of the invention typically has an enthalpy of fusion ΔH2_{(A)} of less than 150 J/g, preferably of less than 100 J/g and especially preferably of less than 80 J/g, measured in each case by means of differential scanning calorimetry (DSC) according to ISO 11357-4:2014.

Suitable semicrystalline terephthalate polyesters (A) generally have a viscosity number (VN(A)) in the range from 50 to 220 ml/g, preferably in the range from 80 to 210 ml/g and especially preferably in the range from 90 to 200 ml/g, determined in a 5 mg/ml by weight solution in a phenol/o-dichlorobenzene mixture (weight ratio 1:1 at 25° C.) to ISO 1628.

Component (A) of the invention typically has a melting temperature (T_{M(A)}). Preferably, the melting temperature (T_{M(A)}) of component (A) is in the range from 130 to 210° C., more preferably in the range from 135 to 205° C. and especially preferably in the range from 140 to 180° C.

Suitable components (A) have a weight-average molecular weight (M_{W(A)}) in the range from 500 to 2 000 000 g/mol, preferably in the range from 10 000 to 90 000 g/mol and especially preferably in the range from 20 000 to 70 000 g/mol. Weight-average molecular weight (M_{W(A)}) is determined by means of SEC-MALLS (Size Exclusion Chromatography-Multi-Angle Laser Light Scattering) according to Chi-san Wu “Handbook of size exclusion chromatography and related techniques”, page 19.

The semicrystalline terephthalate polyester (A) can be prepared by all methods known to those skilled in the art.

In the context of the present invention, the at least one semicrystalline terephthalate polyester (A) is prepared by reacting at least components (a) and (b):
(a) at least one aromatic dicarboxylic acid and
(b) at least two aliphatic diols (b1) and (b2), where the aliphatic diol (b1) is neopentyl glycol.

The conversion at least of components (a) and (b) is typically effected in a condensation reaction. The term “condensation reaction” is known in principle to the person skilled in the art. In the context of the present invention, the term “condensation reaction” is understood to mean the reaction at least of components (a) and (b) with elimination of water and/or alcohol to obtain the semicrystalline terephthalate polyester (A).

The molar ratio of component (a) to component (b) in the preparation of the at least one semicrystalline terephthalate polyester (A) is preferably in the range from 1:0.8 to 1:1.1 [mol/mol], more preferably in the range from 1:0.85 to 1:1.05 [mol/mol].

Component (a)

Component (a) is at least one aromatic dicarboxylic acid.

The expressions “at least one aromatic dicarboxylic acid” and “component (a)” in the context of the present invention are used synonymously and have the same meaning. Furthermore, in the context of the present invention, the expression “at least one aromatic dicarboxylic acid” is understood to mean exactly one aromatic dicarboxylic acid, and mixtures of two or more aromatic dicarboxylic acids. In a preferred embodiment, in the method of the invention, exactly one aromatic dicarboxylic acid is used.

Aromatic dicarboxylic acids are known in principle to those skilled in the art.

Aromatic dicarboxylic acids in the context of the present invention are understood to mean the aromatic dicarboxylic acids themselves and the derivatives of the aromatic dicarboxylic acids, such as aromatic dicarboxylic esters. Esters of the aromatic dicarboxylic acids include the di-C₁-C₆-alkyl esters of the aromatic dicarboxylic acids, for example the dimethyl, diethyl, di-n-propyl, diisopropyl, di-n-butyl, diisobutyl, di-t-butyl, di-n-pentyl, diisopentyl or di-n-hexyl esters of the aromatic dicarboxylic acids.

Examples of aromatic dicarboxylic acids are terephthalic acid, isophthalic acid, phthalic acid or the naphthalenedicarboxylic acids.

In the context of the present invention, the at least one aromatic dicarboxylic acid is preferably an aromatic dicarboxylic acids having 6 to 12 and preferably one having 6 to 8 carbon atoms, more preferably one having 8 carbon atoms. The at least one aromatic dicarboxylic acid may be linear or branched.

In a preferred embodiment of the present invention, the at least one aromatic dicarboxylic acid is selected from the group consisting of terephthalic acid, isophthalic acid and phthalic acid.

It will be appreciated that it is also possible to use the esters of the abovementioned aromatic dicarboxylic acids as component (a). It is possible here to use the esters of the abovementioned aromatic dicarboxylic acids individually or else as a mixture of two or more esters of the aromatic dicarboxylic acids.

Furthermore, it is also possible to use a mixture of at least one aromatic dicarboxylic acid and at least one ester of an aromatic dicarboxylic acid.

Component (b)

Component (b) comprises at least two aliphatic diols (b1) and (b2), where the aliphatic diol (b1) is neopentyl glycol.

The expressions “at least two aliphatic diols (b1) and (b2), where the aliphatic diol (b1) is neopentyl glycol” and “component (b)” are used synonymously in the context of the present invention and have the same meaning. Furthermore, in the context of the present invention, the expression “at least two aliphatic diols (b1) and (b2)” is understood to mean exactly two aliphatic diols (b1) and (b2) and mixtures of three aliphatic diols (b1), (b2) and (b3) or more aliphatic diols (b1), (b2), (b3) and (bx). The expression “at least two aliphatic diols (b1) and (b2), where the aliphatic diol (b1) is neopentyl glycol” in the context of the present invention is also understood to mean neopentyl glycol and exactly one further aliphatic diol (b2), and mixtures of neopentyl glycol, the aliphatic diol (b2) and a further aliphatic diol (b3), or neopentyl glycol, the aliphatic diols (b2) and (b3) and more aliphatic diols (bx).

In the context of the present invention, the aliphatic diol (b2) is preferably different than the aliphatic diol (b1). The aliphatic diols (b3) and (bx) are preferably likewise different than the aliphatic diol (b1).

Aliphatic diols are known in principle to the person skilled in the art.

Examples of aliphatic diols are ethylene glycol, propane-1,3-diol, butane-1,4-diol, pentane-1,5-diol, hexane-1,6-diol, neopentyl glycol, 2-ethyl-2-butylpropane-1,3-diol, 2-ethyl-2-isobutylpropane-1,3-diol, cyclohexane-1,4-dimethanol, 2,2,4-trimethylhexane-1,6-diol, polyethylene glycol, diols of the dimer fatty acids or 2,2,4,4-tetramethylcyclobutane-1,3-diol.

In the context of the present invention, the aliphatic diol (b1) is neopentyl glycol and the aliphatic diol (b2) is preferably
i) a linear diol of the general formula (I)

HO—(CH₂)ₙ—OH (I)
in which n is 2, 3, 4, 5 or 6, more preferably 4, or
ii) a diol having a cycloalkyl radical, more preferably cyclohexanedimethanol or 2,2,4,4-tetramethylcyclobutane-1,3-diol.

In the case that the at least one semicrystalline terephthalate polyester (A) is prepared by the reaction of further aliphatic diols (b3) to (bx) with component (a), these are preferably selected from linear diols of the general formula (I) in which n is 2, 3, 4, 5 or 6, and/or from diols having a cycloalkyl radical.

The molar ratio of component (a) to component (b1) in the preparation of the at least one semicrystalline terephthalate polyester (A) is in the range from 1:0.15 to 1:0.65 [mol/mol], more preferably in the range from 1:0.2 to 1:0.5 [mol/mol].

In a preferred embodiment, the at least one semicrystalline terephthalate polyester (A) is prepared by reacting at least components (a) and (b):
(a) terephthalic acid and
(b) at least two aliphatic diols (b1) and (b2), where the aliphatic diol (b1) is neopentyl glycol and the aliphatic diol (b2) is
   i) a linear diol of the general formula (I)

HO—(CH₂)ₙ—OH (I)
in which n is 2, 3, 4, 5 or 6, or
ii) a diol having a cycloalkyl radical, more preferably cyclohexanedimethanol or 2,2,4,4-tetramethylcyclobutane-1,3-diol.

In a particularly preferred embodiment, the at least one semicrystalline terephthalate polyester (A) is prepared by reacting at least components (a) and (b):
(a) terephthalic acid and
(b) at least two aliphatic diols (b1) and (b2), where the aliphatic diol (b1) is neopentyl glycol and the aliphatic diol (b2) is butane-1,4-diol.

In this embodiment, the at least one semicrystalline terephthalate polyester (A) is preferably prepared by reacting at least components (a) and (b):
(a) terephthalic acid and
(b) at least two aliphatic diols (b1) and (b2), where the aliphatic diol (b1) is neopentyl glycol and the aliphatic diol (b2) is butane-1,4-diol,

where the molar ratio of component (a) to component (b) is in the range from 1:0.8 to 1:1.1 [mol/mol] and the molar ratio of component (a) to component (b1) is in the range from 1:0.1 to 1:0.75 [mol/mol].

In the condensation of components (a) and (b), it is additionally possible to use at least one chain extender as an optional component (c).

The expressions “at least one chain extender” and “component (c)” in the context of the present invention are used synonymously and have the same meaning. Furthermore, in the context of the present invention, the expression “at least one chain extender” is understood to mean exactly one chain extender, and mixtures of two or more chain extenders. In a preferred embodiment, exactly one chain extender is used.

The at least one chain extender is preferably selected from the group consisting of compounds comprising at least three groups capable of ester formation (c1) and from compounds comprising at least two isocyanate groups (c2). Epoxides are likewise suitable chain extenders.

In the case that at least one chain extender is used as component (c), the at least one semicrystalline terephthalic polyester is prepared by reacting at least components (a), (b) and (c):
(a) at least one aromatic dicarboxylic acid,
(b) at least two aliphatic diols (b1) and (b2), where the aliphatic diol (b1) is neopentyl glycol, and
c) at least one chain extender.

The sinter powder (SP) preferably comprises at least 15% by weight of component (A), more preferably at least 17% by weight of component (A), based on the sum total of the percentages by weight of components (A) and optionally (B), (C) and/or (D), preferably based on the total weight of the sinter powder (SP).

The sinter powder (SP) preferably further comprises up to 100% by weight of component (A), more preferably not more than 98.9% by weight, especially preferably not more than 95% by weight, most preferably not more than 92% by weight of component (A), based on the sum total of the percentages by weight of components (A) and optionally (B), (C) and/or (D), preferably based on the total weight of the sinter powder (SP).

Component (B)

Component (B) is at least one further polymer.

What is meant by “at least one further polymer” in the context of the present invention is either exactly one further polymer or a mixture of two or more further polymers.

The at least one further polymer (B) may be a semicrystalline or amorphous polymer.

If the at least one further polymer (B) is semicrystalline, it is preferable in the context of the present invention that the at least one further semicrystalline polymer (B) is different than the at least one semicrystalline terephthalate polyester of component (A).

Preferably, the at least one further polymer (B) is selected from the group consisting of polyolefins, polyesters, polyamides, polycarbonates and polyacrylates, more preferably from polyesters, polycarbonates and polyacrylates.

If the at least one further semicrystalline polymer (B) is selected from polyesters, it is preferably a polycaprolactone.

If the sinter powder comprises component (B), it comprises at least 1% by weight of component (B), preferably at least 2% by weight of component (B), based on the sum total of the percentages by weight of components (A), (B) and optionally (C) and/or (D), preferably based on the total weight of the sinter powder (SP).

If the sinter powder comprises component (B), moreover, it comprises not more than 25% by weight of component (B), preferably not more than 23% by weight of component (B), based on the sum total of the percentages by weight of components (A), (B) and optionally (C) and/or (D), preferably based on the total weight of the sinter powder (SP).

Component (C)

Component (C) is at least one additive.

In the context of the present invention, “at least one additive” means either exactly one additive or a mixture of two or more additives.

Additives as such are known to those skilled in the art. For example, the at least one additive is selected from the group consisting of antinucleating agents, impact modifiers, flame retardants, stabilizers, conductive additives, end group functionalizers, dyes, antioxidants (preferably from sterically hindered phenols) and color pigments.

An example of a suitable antinucleating agent is lithium chloride. Suitable impact modifiers are, for example, ethylene-propylene-diene rubbers, or those based on terpolymers of ethylene, methyl acrylate and glycidyl methacrylate (GMA). Suitable flame retardants are, for example, phosphinic salts. Suitable stabilizers are, for example, phenols, phosphites, for example sodium hypophosphite, and copper stabilizers. Suitable conductive additives are carbon fibers, metals, stainless steel fibers, carbon nanotubes and carbon black. Suitable end group functionalizers are, for example, terephthalic acid, adipic acid and propionic acid. Suitable dyes and color pigments are, for example, carbon black and iron chromium oxides.

An example of a suitable antioxidant is Irganox® 245 from BASF SE or Lotader® AX8900 from Arkema.

If the sinter powder comprises component (C), it comprises at least 0.1% by weight of component (C), preferably at least 1% by weight of component (C), based on the sum total of the percentages by weight of components (A), (C) and optionally (B) and/or (D), preferably based on the total weight of the sinter powder (SP).

If the sinter powder comprises component (C), moreover, it comprises not more than 20% by weight of component (C), based on the sum total of the percentages by weight of components (A), (C) and optionally (B) and/or (D), preferably based on the total weight of the sinter powder (SP).

Component (D)

According to the invention, any component (D) present is at least one reinforcer.

In the context of the present invention, “at least one reinforcer” means either exactly one reinforcer or a mixture of two or more reinforcers.

In the context of the present invention, a reinforcer is understood to mean a material that improves the mechanical properties of shaped bodies produced by the process of the invention compared to shaped bodies that do not comprise the reinforcer.

Reinforcers as such are known to those skilled in the art. Component (D) may, for example, be in spherical form, in platelet form or in fibrous form.

Preferably, the at least one reinforcer is in platelet form or in fibrous form.

A “fibrous reinforcer” is understood to mean a reinforcer in which the ratio of length of the fibrous reinforcer to the diameter of the fibrous reinforcer is in the range from 2:1 to 40:1, preferably in the range from 3:1 to 30:1 and especially preferably in the range from 5:1 to 20:1, where the length of the fibrous reinforcer and the diameter of the fibrous reinforcer are determined by microscopy by means of image evaluation on samples after ashing, with evaluation of at least 70 000 parts of the fibrous reinforcer after ashing.

The length of the fibrous reinforcer in that case is typically in the range from 5 to 1000 μm, preferably in the range from 10 to 600 μm and especially preferably in the range from 20 to 200 μm, determined by means of microscopy with image evaluation after ashing.

The diameter in that case is, for example, in the range from 1 to 30 μm, preferably in the range from 2 to 20 μm and especially preferably in the range from 5 to 15 μm, determined by means of microscopy with image evaluation after ashing.

In a further preferred embodiment, the at least one reinforcer is in platelet form. In the context of the present invention, “in platelet form” is understood to mean that the particles of the at least one reinforcer have a ratio of diameter to thickness in the range from 4:1 to 10:1, determined by means of microscopy with image evaluation after ashing.

Suitable reinforcers are known to those skilled in the art and are selected, for example, from the group consisting of carbon nanotubes, carbon fibers, boron fibers, glass fibers, glass beads, silica fibers, ceramic fibers, basalt fibers, aluminosilicates, aramid fibers and polyester fibers.

The at least one reinforcer is preferably selected from the group consisting of aluminosilicates, glass fibers, glass beads, silica fibers and carbon fibers.

The at least one reinforcer is more preferably selected from the group consisting of aluminosilicates, glass fibers, glass beads and carbon fibers. These reinforcers may additionally have been epoxy-functionalized.

Suitable silica fibers are, for example, wollastonite and halloysite.

Suitable aluminosilicates are known as such to the person skilled in the art. Aluminosilicates refer to compounds comprising Al₂O₃ and SiO₂. In structural terms, a common factor among the aluminosilicates is that the silicon atoms are tetrahedrally coordinated by oxygen atoms and the aluminum atoms are octahedrally coordinated by oxygen atoms. Aluminosilicates may additionally comprise further elements.

Preferred aluminosilicates are sheet silicates. Particularly preferred aluminosilicates are calcined aluminosilicates, especially preferably calcined sheet silicates. The aluminosilicate may additionally have been epoxy-functionalized.

If the at least one reinforcer is an aluminosilicate, the aluminosilicate may be used in any form. For example, it can be used in the form of pure aluminosilicate, but it is likewise possible that the aluminosilicate is used in mineral form. Preferably, the aluminosilicate is used in mineral form. Suitable aluminosilicates are, for example, feldspars, zeolites, sodalite, sillimanite, andalusite and kaolin. Kaolin is a preferred aluminosilicate.

Kaolin is one of the clay rocks and comprises essentially the mineral kaolinite. The empirical formula of kaolinite is Al₂[(OH)₄/Si₂O₅]. Kaolinite is a sheet silicate. As well as kaolinite, kaolin typically also comprises further compounds, for example titanium dioxide, sodium oxides and iron oxides. Kaolin preferred in accordance with the invention comprises at least 98% by weight of kaolinite, based on the total weight of the kaolin.

If the sinter powder comprises component (D), it comprises at least 5% by weight of component (D), more preferably at least 10% by weight of component (D), based on the sum total of the percentages by weight of components (A), (D) and optionally (B) and/or (C), preferably based on the total weight of the sinter powder (SP).

If the sinter powder comprises component (D), moreover, it preferably comprises not more than 40% by weight of component (D), based on the sum total of the percentages by weight of components (A), (D) and optionally (B) and/or (C), preferably based on the total weight of the sinter powder (SP).

Method of Producing the Shaped Bodies

The present invention further provides a method of producing a shaped body, comprising the steps of:
a) providing a layer of the sinter powder (SP),
b) optionally heating the layer up to a maximum of 2 K below the melting temperature T_{M} of the sinter powder (SP),
c) exposing the layer of the sinter powder (SP) provided in step a) or optionally heated in step b), preferably in a sintering method, more preferably in a selective laser sintering method, in a high-speed sintering (HSS) method or a multijet fusion (MJF) method.

In step c), the layer of the sinter powder (SP) provided in step a), or optionally step b), is exposed.

On exposure, at least some of the layer of the sinter powder (SP) melts. The molten sinter powder (SP) coalesces and forms a homogeneous melt. After the exposure, the molten part of the layer of the sinter powder (SP) cools down again and the homogeneous melt solidifies again.

Suitable methods of exposure include all methods known to those skilled in the art. Preferably, the exposure in step c) is effected with a radiation source. The radiation source is preferably selected from the group consisting of infrared sources and lasers. Especially preferred infrared sources are near infrared sources.

The present invention therefore also provides a method in which the exposing in step c) is effected with a radiation source selected from the group consisting of lasers and infrared sources.

Suitable lasers are known to those skilled in the art and are for example semiconductor fiber lasers, solid-state lasers, for example Nd:YAG lasers (neodymium-doped yttrium aluminum garnet lasers), or carbon dioxide lasers. The carbon dioxide laser typically has a wavelength of 10.6 μm. Other usable lasers emit radiation in the range from 350 to 2500 nm.

If the radiation source used in the exposing in step c) is a laser, the layer of the sinter powder (SP) provided in step a), or optionally step b), is typically exposed locally and briefly to the laser beam. This selectively melts just the parts of the sinter powder (SP) that have been exposed to the laser beam. If a laser is used in step c), the method of the invention is also referred to as selective laser sintering. Selective laser sintering is known per se to those skilled in the art.

If the radiation source used in the exposing in step c) is an infrared source, especially a near infrared source, the wavelength at which the radiation source radiates is typically in the range from 680 nm to 3000 nm, preferably in the range from 750 nm to 1500 nm and especially in the range from 880 nm to 1100 nm.

In the exposing in step c), in that case, the entire layer of the sinter powder (SP) is typically exposed. In order that only the desired regions of the sinter powder (SP) melt in the exposing, an infrared-absorbing ink (IR-absorbing ink) is typically applied to the regions that are to melt.

The method of producing the shaped body in that case preferably comprises, between step a) and optionally between step b) or step c), a step a-1) of applying at least one IR-absorbing ink to at least part of the layer of the sinter powder (SP) provided in step a).

The present invention therefore also further provides a method of producing a shaped body, comprising the steps of
a) providing a layer of a sinter powder (SP) comprising the following components (A) and optionally (B), (C) and/or (D):
   (A) at least one semicrystalline terephthalate polyester which is prepared by reacting at least components (a) and (b):
      (a) at least one aromatic dicarboxylic acid and
      (b) at least two aliphatic diols (b1) and (b2), where the aliphatic diol (b1) is neopentyl glycol,
   (B) optionally at least one further polymer
   (C) optionally at least one additive and/or
   (D) optionally at least one reinforcer,
a-1) applying at least one IR-absorbing ink to at least part of the layer of the sinter powder (SP) provided in step a),
b) optionally heating the layer up to a maximum of 2 K below the melting temperature T_{M} of the sinter powder (SP),
c) exposing the layer of the sinter powder (SP) provided in step a) or optionally heated in step b).

Suitable IR-absorbing inks are all IR-absorbing inks known to those skilled in the art, especially IR-absorbing inks known to those skilled in the art for high-speed sintering.

IR-absorbing inks typically comprise at least one absorber that absorbs IR radiation, preferably NIR radiation (near infrared radiation). In the exposing of the layer of the sinter powder (SP) in step c), the absorption of the IR radiation, preferably the NIR radiation, by the IR absorber present in the IR-absorbing inks results in selective heating of the part of the layer of the sinter powder (SP) to which the IR-absorbing ink has been applied.

The IR-absorbing ink may, as well as the at least one absorber, comprise a carrier liquid. Suitable carrier liquids are known to those skilled in the art and are, for example, oils or solvents.

The at least one absorber may be dissolved or dispersed in the carrier liquid.

If the exposure in step c) is effected with a radiation source selected from infrared sources and if step a-1) is conducted, the method of the invention is also referred to as high-speed sintering (HSS) or multijet fusion (MJF) method. These methods are known per se to those skilled in the art.

After step c), the layer of the sinter powder (SP) is typically lowered by the layer thickness of the layer of the sinter powder (SP) provided in step a) and a further layer of the sinter powder (SP) is applied. This is subsequently optionally heated again in step b) and exposed again in step c).

This firstly bonds the upper layer of the sinter powder (SP) to the lower layer of the sinter powder (SP); in addition, the particles of the sinter powder (SP) within the upper layer are bonded to one another by fusion.

In the process of the invention, steps a) to c) and optionally a-1) can thus be repeated.

By repeating the lowering of the powder bed, the applying of the sinter powder (SP) and the exposure and hence the melting of the sinter powder (SP), three-dimensional shaped bodies are produced. It is possible to produce shaped bodies that also have cavities, for example. No additional support material is necessary since the unmolten sinter powder (SP) itself acts as a support material.

The present invention therefore also further provides a shaped body obtainable by the method of the invention.

Of particular significance in the method of the invention is the melting range of the sinter powder (SP), called the sintering window (W_{SP}) of the sinter powder (SP).

The sintering window (W_{SP}) of the sinter powder (SP) can be determined by differential scanning calorimetry (DSC) for example.

In differential scanning calorimetry, the temperature of a sample, i.e. in the present case a sample of the sinter powder (SP), and the temperature of a reference are altered linearly over time. To this end, heat is supplied to/removed from the sample and the reference. The amount of heat Q necessary to keep the sample at the same temperature as the reference is determined. The amount of heat QR supplied to/removed from the reference serves as a reference value.

If the sample undergoes an endothermic phase transformation, an additional amount of heat Q must be supplied to keep the sample at the same temperature as the reference. If an exothermic phase transformation takes place, an amount of heat Q has to be removed to keep the sample at the same temperature as the reference. The measurement affords a DSC diagram in which the amount of heat Q supplied to/removed from the sample is plotted as a function of temperature T.

Measurement typically involves initially performing a heating run (H), i.e. the sample and the reference are heated in a linear manner. During the melting of the sample (solid/liquid phase transformation), an additional amount of heat Q has to be supplied to keep the sample at the same temperature as the reference. In the DSC diagram, a peak known as the melting peak is then observed.

After the heating run (H), a cooling run (C) is typically measured. This involves cooling the sample and the reference linearly, i.e. heat is removed from the sample and the reference. During the crystallization/solidification of the sample (liquid/solid phase transformation), a greater amount of heat Q has to be removed to keep the sample at the same temperature as the reference, since heat is liberated in the course of crystallization/solidification. In the DSC diagram of the cooling run (C), a peak, called the crystallization peak, is then observed in the opposite direction from the melting peak.

In the context of the present invention, the heating during the heating run is typically effected at a heating rate in the range from 5 to 25 K/min, preferably at a heating rate in the range from 5 to 15 K/min. The cooling during the cooling run, in the context of the present invention, is typically effected at a cooling rate in the range from 5 to 25 K/min, preferably at a cooling rate in the range from 5 to 15 K/min.

A DSC diagram with a heating run (H) and a cooling run (K) with a heating rate/cooling rate in the range from 5 to 15 K is shown by way of example in FIG. 1. The DSC diagram can be used to determine the onset temperature of melting (T_{M}^{onset}) and the onset temperature of crystallization (T_{C}^{onset}).

To determine the onset temperature of melting (T_{M}^{onset}), a tangent is drawn against the baseline of the heating run (H) at the temperatures below the melting peak. A second tangent is drawn against the first point of inflection of the melting peak at temperatures below the temperature at the maximum of the melting peak. The two tangents are extrapolated until they intersect. The vertical extrapolation of the intersection to the temperature axis denotes the onset temperature of melting (T_{M}^{onset}).

To determine the onset temperature of crystallization (Tense), a tangent is drawn against the baseline of the cooling run (C) at the temperatures above the crystallization peak. A second tangent is drawn against the point of inflection of the crystallization peak at temperatures above the temperature at the minimum of the crystallization peak. The two tangents are extrapolated until they intersect. The vertical extrapolation of the intersection to the temperature axis indicates the onset temperature of crystallization (T_{C}^{onset}).

The sintering window (W) results from the difference between the onset temperature of melting (T_{M}^{onset}) and the onset temperature of crystallization (T_{C}^{onset}). Thus:

W=T_{M}^{onset}−T_{C}^{onset}.

In the context of the present invention, the terms “sintering window (W_{SP})”, “size of the sintering window (WSP)” and “difference between the onset temperature of melting (T_{M}^{onset}) and the onset temperature of crystallization (T_{C}^{onset})” have the same meaning and are used synonymously.

The sinter powder (SP) of the invention is of particularly good suitability for use in a sintering method.

The present invention therefore also provides for the use of a sinter powder (SP) comprising the following components (A) and optionally (B), (C) and/or (D):
(A) at least one semicrystalline terephthalate polyester which is prepared by reacting at least components (a) and (b):
   (a) at least one aromatic dicarboxylic acid and
   (b) at least two aliphatic diols (b1) and (b2), where the aliphatic diol (b1) is neopentyl glycol,
(B) at least one further polymer,
(C) optionally at least one additive and/or
(D) optionally at least one reinforcer, in a sintering method, preferably in a selective laser sintering method, in a high-speed sintering method (HSS) or a multijet fusion method (MJF).

Shaped Bodies

The method of the invention affords a shaped body. The shaped body can be removed from the powder bed directly after the solidification of the sinter powder (SP) molten on exposure in step c). It is likewise possible first to cool the shaped body and only then to remove it from the powder bed. Any adhering particles of the sinter powder that have not been melted can be mechanically removed from the surface by known methods. Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surface.

The present invention therefore further provides a shaped body obtainable by the method of the invention.

The shaped bodies obtained typically comprise in the range from 15% to 100% by weight of component (A), in the range from 0% to 25% by weight of component (B), in the range from 0% to 20% by weight of component (C) and in the range from 0% to 40% by weight of component (D), based in each case on the total weight of the shaped body.

In a preferred embodiment, the shaped body comprises in the range from 15% to 95% by weight of component (A), in the range from 0% to 25% by weight of component (B), in the range from 0% to 20% by weight of component (C) and in the range from 5% to 40% by weight of component (D), based in each case on the total weight of the shaped body.

In an alternative preferred embodiment, the -shaped body comprises

in the range from 15% to 98.9% by weight, preferably in the range from 17% to 92% by weight, of component (A),

in the range from 1% to 25% by weight, preferably in the range from 2% to 23% by weight, of component (B),

in the range from 0.1% to 20% by weight, preferably in the range from 1% to 20% by weight, of component (C) and

in the range from 0% to 40% by weight, preferably in the range from 5% to 40% by weight, of component (D),

based in each case on the total weight of the shaped body.

In general, component (A) is the component (A) that was present in the sinter powder (SP). It is likewise the case that component (B) is the component (B) that was present in the sinter powder (SP), the component (C) is the component (C) that was present in the sinter powder (SP), and the component (D) is the component (D) that was present in the sinter powder (SP).

If step a-1) has been conducted, the shaped body additionally typically comprises the IR-absorbing ink.

It will be clear to the person skilled in the art that, as a result of the exposure of the sinter powder (SP), components (A) and optionally (B), (C) and (D) can enter into chemical reactions and can be altered as a result. Such reactions are known to those skilled in the art.

Preferably, components (A) and optionally (B), (C) and (D) do not enter into any chemical reaction on exposure in step c); instead, the sinter powder (SP) merely melts.

The resultant shaped body preferably has a tensile modulus of elasticity, determined to ISO 527-1:2012, of at least 1000 MPa, more preferably of at least 1400 MPa, and especially preferably of at least 1800 MPa.

In addition, the resultant shaped body preferably has a tensile strength, determined to ISO 527-1:2012, of at least 15 MPa, more preferably of at least 20 MPa, and especially preferably of at least 25 MPa.

In a further embodiment of the present invention, the sinter powder (SP) comprises the following components (A) and optionally (B), (C) and/or (D):

(A) at least one semicrystalline terephthalate polyester which is prepared by reacting at least components (a) and (b):
(a) at least one aromatic dicarboxylic acid and
(b) at least two aliphatic diols (b1) and (b2), where the aliphatic diol (b1) is neopentyl glycol,
(B) optionally at least one further polymer,
(C) optionally at least one additive and/or
(D) optionally at least one reinforcer.

Preferably, the molar ratio of component (a) to component (b1) in the preparation of the at least one semicrystalline terephthalate polyester (A) is in the range from 1:0.1 to 1:0.75 [mol/mol]. The embodiments and preferences specified above relating to the sinter powder (SP) according to claim 1 are analogously applicable here.

The invention is elucidated in detail hereinafter by examples, without restricting it thereto.

### EXAMPLES

The following components are used:

Semicrystalline Terephthalate Polyester
Component (A) in inventive examples E1, E2, E4, E5, E6 and E7
Advanite 53001 terephthalate polyester (pelletized material; Sasa Polyester Sanayi A.S., Turkey), prepared by reaction of components (a), (b1) and (b2):
52.4 mol % of terephthalic acid (component (a)), based on the total amount of components (a), (b1) and (b2),
12.2 mol % of neopentyl glycol (component (b1)), based on the total amount of components (a), (b1) and (b2), and
35.4 mol % of butanediol (component (b2)), based on the total amount of components (a), (b1) and (b2).

Semicrystalline Terephthalate Polyester in Comparative Example CE3
Ultradur B4500 polybutylene terephthalate (pelletized material; BASF SE), prepared by reaction of components (a) and (b2):
50 mol % of terephthalic acid or dimethyl terephthalate (corresponding to component (a)), based on the total amount of components (a) and (b2), and
50 mol % of butane-1,4-diol (corresponding to component (b2)), based on the total amount of components (a) and (b2).

Further Polymer (Component (8)) in Inventive Examples E6 and E7
Capa® 6500 polycaprolactone (pelletized material; Perstorp)

Additive (Component (C)) in Inventive Examples E6 and E7
Irganox® 245 antioxidant (BASF SE; sterically hindered phenol)

Reinforcer (Component (D)) in Inventive Examples E4 and E5
glass beads (Spheriglass® 2000 CP0202; Potters; B4)
wollastonite (TREMIN® 939-300 EST; HPF; B5)

Flow Aid
Aeroxide® Alu C (Evonik)

Test Methods:

The enthalpies of fusion ΔH1 and ΔH2, melting temperature (T_{M1}) and glass transition temperature (T_{G2}) were each determined by means of dynamic scanning calorimetry.

For determination of the melting temperature (T_{M1}) and the first enthalpy of fusion ΔH1, as described above, a first heating run (H1) at a heating rate of 20 K/min was measured. For determination of the second enthalpy of fusion ΔH2, as described above, a second heating run (H2) at a heating rate of 20 K/min was measured. The melting temperature (T_{M1}) then corresponded to the temperature at the maximum of the melting peak of the heating run (H1). The enthalpies of fusion ΔH1_{(SP)} and ΔH2_{(SP)} of the sinter powder (SP) are proportional to the area beneath the melting peak of the first heating (H1) and of the second heating run (H2) respectively in the DSC diagram.

For determination of the glass transition temperature (T_{G2}), after the first heating run (H1), a cooling run (K) and subsequently a second heating run (H2) were measured. The cooling run was measured at a cooling rate of 20 K/min; the first heating run (H1) and the second heating run (H2) were measured at a heating rate of 20 K/min. The glass transition temperature (T_{G2}) was then determined as described above at half the step height of the second heating run (H2).

The crystallization temperature (T_{C}) was determined by means of differential scanning calorimetry. For this purpose, first a heating run (H) at a heating rate of 20 K/min and then a cooling run (C) at a cooling rate of 20 K/min were measured. The crystallization temperature (T_{C}) is the temperature at the extreme of the crystallization peak.

Complex shear viscosity was determined using freshly produced sinter powders. Viscosity was measured here by means of rotary rheology at a measurement frequency of 0.5 rad/s at a temperature of 190° C. (E1, E2, E6 and E7) or 240° C. (CE3).

Production of the Sinter Powders

### Inventive Examples E1, E2, E4 and E5 and Comparative Example CE3

The pelletized materials of the semicrystalline terephthalate polyesters were each ground while cooling with liquid nitrogen in a pinned disk mill to a particle size (D50) in the region of less than 150 μm to obtain a terephthalate polyester powder. The resultant terephthalate polyester powder was mixed with 0.2% by weight of flow aid, based on the total weight of the terephthalate polyester powder and the flow aid, or, based on the total weight of the sinter powder, to obtain the sinter powder (SP).

In inventive example E2, the resultant sinter powder (SP) was subsequently subjected to heat treatment at a temperature of 120° C. for 20 hours in a drying cabinet under reduced pressure to obtain a heat-treated sinter powder (SP). In inventive example E1, the sinter powder (SP) was not heat-treated. In inventive examples E4 and E5, after the sinter powder had been heat treated, a reinforcer (component (D)), glass beads (E4) and wollastonite (E5) were mixed in. The compositions of the sinter powders (SP) and of the heat-treated sinter powders (SP) are shown in tables 1 and 2; the physical properties of the sinter powders (SP) and of the heat-treated sinter powders (SP) are shown in tables 4 and 5.

### Inventive Examples E6 and E7

The pellets of the semicrystalline terephthalate polyester (component (A)) and of the further polymer (component (B); polycaprolactone) and the antioxidant (component (C)) in the amounts specified in table 3 were mixed in an extruder to obtain an extrudate (E) and then pelletized to obtain a pelletized material (G). Subsequently, the pelletized material (G) was ground while cooling with liquid nitrogen in a pinned disk mill to a particle size (D50) in the region of less than 150 μm to obtain the sinter powder (SP). In inventive examples E6 and E7, the sinter powder (SP) was not heat-treated. The physical properties of the sinter powders (SP) are shown in tables 4 and 5.

TABLE 1

| Example/ | Terephthalate | Component | Component | Component | |
|---|---|---|---|---|---|
| Comparative | polyester powder | (a) | (b1) | (b2) | Flow aid |
| example | [% by wt]* | [mol %]** | [mol %]** | [mol %]** | [% by wt.]* |
| E1 | 99.8 | 52.4 | 12.2 | 35.4 | 0.2 |
| E2 | 99.8 | 52.4 | 12.2 | 35.4 | 0.2 |
| CE3 | 99.8 | 50 | — | 50 | 0.2 |

*based on the tota weight of the sinter powder
**based on the tota amount c of components (a), (b1) and (b2)

TABLE 2

| | Terephthalate | | | | | |
|---|---|---|---|---|---|---|
| Example/ | polyester | Component | Component | Component | | |
| comparative | powder | (a) | (b1) | (b2) | Flow aid | Reinforcer |
| example | [symbol] | [mol %]** | [mol %]** | [% by wt.]* | [% by wt.]* | [% by wt.]* |
| E4 | 82.83 | 52.4 | 12.2 | 35.4 | 0.17 | 17 |
| E5 | 82.83 | 52.4 | 12.2 | 35.4 | 0.17 | 17 |

*based on the tota weight of the sinter powder
**based on the total amount of components (a), (b1) and (b2) [symbol]
indicates data missing or illegible when filed

TABLE 3

| | | | | | Component | Component |
|---|---|---|---|---|---|---|
| Example/ | Component | Component | Component | Component | (B) | (C) |
| comparative | (A) | (a) | (b1) | (b2) | [% by | [% by |
| example | [% by wt.]* | [mol %]** | [mol %]** | [mol %]** | wt [symbol] ]* | wt [symbol] ]* |
| E6 | 97.25 | 52.4 | 12.2 | 35.4 | 2.5 | 0.25 |
| E7 | 94.75 | 52.4 | 12.2 | 35.4 | 5.0 | 0.25 |

*based on the total weight of the sinter powder
**based on the total amount of components (a), (b1) and (b2) [symbol]
indicates data missing or illegible when filed

TABLE 4

| Example/ | | | |
|---|---|---|---|
| comparative | D10 | D50 | D90 |
| example | [μm] | [μm] | [μm] |
| E1 | 37 | 62 | 101 |
| E2 | 37 | 62 | 101 |
| CE3 | 30.7 | 61.5 | 115.6 |
| E6 | | | |
| E7 | | | |

TABLE 5

| | Complex | | | | | | |
|---|---|---|---|---|---|---|---|
| | shear | | | | | | |
| Example/ | viscosity | | | | | | |
| comparative | at 0.5 rad/ | T_{M1} | T_{G2} | T_{C} | ΔH₁ | ΔH₂ | ΔH₁ − ΔH₂ |
| example | s [Pas] | [° C.] | [° C.] | [° C.] | [J/g] | [J/g] | [J/g] |
| E1 | 1500 | 83.1 | 43.0 | 100.1 | 30 | 2 | 28 |
| | | 167.1 | | | | | |
| E2 | 1540 | 167.5 | 44.0 | 101.0 | 38 | 3 | 35 |
| CE3 | 580 | 221.9 | 42.0 | 190.8 | 53 | 59 | 6 |
| E4 | — | 167.1 | 44.0 | 103.0 | 31 | 4 | 27 |
| E5 | — | 168.4 | 44.0 | 114.0 | 29 | 10 | 19 |
| E6 | 315 | 168.0 | 42.0 | 100.6 | 32 | 17 | 15 |
| E7 | 320 | 167.4 | 38.0 | 98.6 | 26 | 12 | 14 |

The sinter powders of inventive examples E1, E2, E3, E4, E5, E6 and E7 show a distinctly lower melting temperature (T_{M1}) than the sinter powder of comparative example CE3, as a result of which the sinter powders of inventive examples E1, E2, E3, E4, E5, E6 and E7 can be used without difficulty in all standard laser sintering systems with maximum build space temperatures of 200° C. The sinter powders of inventive examples E1, E2, E3, E4, E5, E6 and E7 likewise feature very slow crystallization compared to the sinter powder of comparative example CE3, which shows the difference in the enthalpies of fusion from the first and second heating runs, and which achieves a distinctly broadened sintering window.

On comparison of examples E1 and E2, it is clear that an additional, low-lying fusion peak (83.1° C.) occurs in the case of E1. The effect of this is tackiness in the SLS process, which makes sinter powder E1 more difficult to process (see table 7). Heat treatment (example E2) leads to disappearance of this low-lying melting peak in the first heating run and to improved processibility.

This peak does not occur in inventive examples E6 and E7.

Laser Sintering Experiments

The sinter powder was introduced with a layer thickness of 0.1 mm into the cavity at the temperature specified in table 6. The sinter powder was subsequently exposed to a laser with the laser power output specified in table 6 and the point spacing specified, with a speed of the laser over the sample during exposure of 15 m/s. The point spacing is also known as laser spacing or lane spacing. Selective laser sintering typically involves scanning in stripes. The point spacing gives the distance between the centers of the stripes, i.e. between the two centers of the laser beam for two stripes.

TABLE 6

| Example/ | | Laser power | Laser | Point |
|---|---|---|---|---|
| comparative | Temperature | output | speed | spacing |
| example | [° C.] | [W] | [m/s] | [mm] |
| E1 | 140 | 50 | 15 | 0.18 |
| E2 | 135-155 | 50 | 15 | 0.18 |
| CE3 | 205-215 | 50 | 15 | 0.18 |
| E4 | 140 | 50 | 15 | 0.18 |
| E5 | 140 | 50 | 15 | 0.18 |

It is clear that the temperature with which the sinter powder of inventive examples E1 and E2 enters the build space, at 25° C. below the melting temperature, is very low compared to the temperature at which the sinter powder of comparative example CE3 was introduced into the build space.

Subsequently, the properties of the tensile bars (sinter bars) obtained were determined. The tensile bars (sinter bars) obtained were tested in the dry state after drying at 80° C. for 336 h under reduced pressure. The results are shown in table 7. In addition, Charpy specimens were produced, which were likewise tested in dry form (according to ISO179-2/1eU: 1997+Amd.1:2011).

Processibility was assessed qualitatively with “2” meaning “good”, i.e. low warpage of the component, and “5” meaning “inadequate”, i.e. severe warpage of the component.

Tensile strength, tensile modulus of elasticity and elongation at break were determined according to ISO 527-1:2012.

TABLE 7

| | | | | | Charpy impact | |
|---|---|---|---|---|---|---|
| Example/ | | | Tensile | | resistance, | Charpy impact |
| comparative | Processibility | Tensile | modulus of | Elongation at | unnotched | resistance, |
| example | in SLS | strength [MPa] | elasticity [MPa] | break [%] | [kJ/m²] | notched [kJ/m²] |
| E1 | 3 | 45 | 2300 | 2.5 | n.d. | n.d. |
| E2 | 1 | 37-45 | 2300-2430 | 1.7-2.5 | 9-12 | 2.2 ± 0.2 |
| CE3 | 6 | n.d* | n.d* | n.d* | n.d* | n.d* |
| E4 | 1 | 42 ± 1.3 | 2850 ± 45 | 1.7 ± 0.1 | 7.4 ± 0.6 | 1.6 ± 0.3 |
| E5 | 1 | 45 ± 0.7 | 3740 ± 85 | 1.7 ± 0.1 | 13.1 ± 1.5 | 1.7 ± 0.2 |

*No mechanically testable components were obtained since warpage was too great

The shaped bodies produced from the inventive sinter powders according to examples E1, E2, E4 and E5 have reduced warpage together with a high tensile modulus of elasticity and high tensile strength. The mixing of a reinforcer (component (D)) into the sinter powder (SP) (E4 and E5) can achieve a further increase in tensile modulus of elasticity and tensile strength.

1.-14. (canceled)

15. A sinter powder (SP) comprising the following components (A) and optionally (B), (C) and/or (D):
(A) at least one semicrystalline terephthalate polyester which is prepared by reacting at least components (a) and (b):
(a) at least one aromatic dicarboxylic acid and
(b) at least two aliphatic diols (b1) and (b2), where the aliphatic diol (b1) is neopentyl glycol,
(B) optionally at least one further polymer,
(C) optionally at least one additive and/or
(D) optionally at least one reinforcer, where
the molar ratio of component (a) to component (b1) in the preparation of the at least one semicrystalline terephthalate polyester (A) is in the range from 1:0.15 to 1:0.65 [mol/mol] and the aliphatic diol (b2) is a linear diol of the general formula (I)
HO—(CH₂)ₙ—OH (I)
in which n is 2, 3, 4, 5 or 6.

16. The sinter powder (SP) according to claim 15, wherein the molar ratio of component (a) to component (b) in the preparation of the at least one semicrystalline terephthalate polyester (A) is in the range from 1:0.8 to 1:1.1 [mol/mol].

17. The sinter powder (SP) according to claim 15, wherein the molar ratio of component (a) to component (b1) in the preparation of the at least one semicrystalline terephthalate polyester (A) is in the range from 1:0.2 to 1:0.5 [mol/mol].

18. The sinter powder (SP) according to claim 15, wherein component (a) is selected from the group consisting of terephthalic acid, isophthalic acid and phthalic acid.

19. The sinter powder (SP) according to claim 15, wherein the sinter powder (SP) has
i. a median particle size (D50) in the range from 10 to 250 μm, and/or
ii. a D10 in the range from 10 to 60 μm,
a D50 in the range from 25 to 90 μm and
a D90 in the range from 50 to 150 μm, and/or
iii. has been heat treated.

20. The sinter powder (SP) according to claim 15, wherein
i) component (B) is a polymer selected from the group consisting of polyolefins, polyesters, polyamides, polycarbonates and polyacrylates, and/or
ii) component (C) is selected from antinucleating agents, impact modifiers, flame retardants, stabilizers, conductive additives, end group functionalizers, dyes, antioxidants and color pigments, and/or
iii) component (D) is selected from the group consisting of carbon nanotubes, carbon fibers, boron fibers, glass fibers, glass beads, silica fibers, ceramic fibers, basalt fibers, aluminum silicates, aramid fibers and polyester fibers.

21. The sinter powder (SP) according to claim 15, wherein the sinter powder (SP) has a melting temperature (T_{M}) in the range from 130 to 210° C., where the melting temperature (T_{M}) is determined by dynamic scanning calorimetry according to the description.

22. The sinter powder (SP) according to claim 15, wherein the sinter powder (SP) has a crystallization temperature (T_{C}) in the range from 70 to 130° C., where the crystallization temperature (T_{M}) is determined by dynamic scanning calorimetry according to the description.

23. The sinter powder according to claim 15, wherein the sinter powder (SP) has a first enthalpy of fusion ΔH1_{(SP)} and a second enthalpy of fusion ΔH2_{(SP)}, where the difference between the first enthalpy of fusion ΔH1_{(SP)} and the second enthalpy of fusion ΔH2_{(SP)} is at least 10 J/g, where the first enthalpy of fusion ΔH1_{(SP)} and the second enthalpy of fusion ΔH2_{(SP)} are determined by dynamic scanning calorimetry according to the description.

24. A method of producing a sinter powder (SP) according to claim 15, comprising the steps of
a) mixing components (A) and optionally (B), (C) and/or (D):
(A) at least one semicrystalline terephthalate polyester which is prepared by reacting at least components (a) and (b):
(a) at least one aromatic dicarboxylic acid and
(b) at least two aliphatic diols (b1) and (b2), where the aliphatic diol (b1) is neopentyl glycol,
(B) optionally at least one further polymer,
(C) optionally at least one additive and/or
(D) optionally at least one reinforcer,
in an extruder to obtain an extrudate (E) comprising components (A) and optionally (B), (C) and/or (D),
b) pelletizing the extrudate (E) obtained in step a) to obtain a pelletized material (G) comprising components (A) and optionally (B), (C) and/or (D),
c) micronizing the pelletized material (G) obtained in step c) to obtain the sinter powder (SP).

25. The method according to claim 24, wherein the sinter powder (SP) obtained in step c) is then heat-treated in a step d) at a temperature T_{T} to obtain a heat-treated sinter powder (SP).

26. A method of producing a shaped body, comprising the steps of:
a) providing a layer of a sinter powder (SP) according to claim 15,
b) optionally heating the layer up to a maximum of 2 K below the melting temperature T_{M} of the sinter powder (SP), where the melting temperature T_{M} is determined by means of dynamic scanning calorimetry according to the description,
c) exposing the layer of the sinter powder (SP) provided in step a) or optionally heated in step b), preferably in a sintering method, more preferably in a selective laser sintering method, in a high-speed sintering (HSS) method or a multijet fusion (MJF) method.

27. A shaped body obtainable by a method according to claim 26.

28. The use of a sinter powder (SP) according to claim 15 in a sintering method, preferably in a selective laser sintering method, in a high-speed sintering (HSS) method or a multijet fusion (MJF) method.
